(19) United States
(12) Patent Application Publication
(10) Pub. No.: US 2026/0368818 A1
(43) Pub. Date: Nov. 19, 2026

(54) ESTATE NOTIFICATION AND DOCUMENT PLATFORM

(71) Applicant: Jillian Hishaw, Charlotte, NC (US)

(72) Inventor: Jillian Hishaw, Charlotte, NC (US)

(21) Appl. No.: 19/638,149

(22) Filed: Apr. 3, 2026

Related U.S. Application Data
(60) Provisional application No. 63/804,698, filed on May 13, 2025.

(51) Int. Cl. G06Q 40/06; G06Q 50/18; G06V 30/10; G06V 30/414

(52) U.S. Cl. CPC G06Q 40/06; G06Q 50/186; G06V 30/10; G06V 30/414

(57) ABSTRACT

A computer-implemented platform receives one or more estate-planning documents associated with a user, extracts structured estate data from the one or more estate-planning documents, stores the structured estate data in association with the user, verifies a death event associated with the user, and transmits a notification to at least one designated recipient using at least a portion of the structured estate data. In some implementations, the platform provides controlled access to one or more estate-planning documents after verification of the death event, redacts personally identifiable information, protected health information, or confidential content identified from the structured estate data, and receives jurisdictional data associated with a power of attorney transaction to determine an embassy or consular filing authority, generate and validate a filing package, and submit the filing package to the embassy or consular filing authority.

### CROSS-REFERENCE TO RELATED APPLICATION

This application claims the benefit of U.S. Provisional Patent Application No. 63/804,698, filed May 13, 2025, entitled “ESTATE NOTIFICATION AND DOCUMENT PLATFORM,” the contents of which are incorporated herein by reference in their entirety.

### FIELD OF THE DISCLOSURE

The present disclosure relates generally to an estate notification and document platform, and more particularly, relates to the platform configured to facilitate the digital management, verification, and distribution of estate-related documents and notifications.

### BACKGROUND

The process of managing estate-planning documents, notifying interested parties upon death, and administering a decedent's estate involves numerous logistical and legal challenges. Estate-planning documents are often stored in disparate locations or unstructured digital formats, making them difficult to locate or authenticate. Notification of death typically depends on manual communication by family members, which may be delayed or incomplete. Verifying death through death certificates or databases often requires administrative effort and may not be integrated with estate management tools. Furthermore, many fiduciaries and beneficiaries lack access to required documents and guidance following death, delaying estate administration and increasing legal risk. Accordingly, a need exists for improved systems that securely store estate-related documents, verify death events, control access to sensitive information, and facilitate timely notifications and related workflows.

### SUMMARY

In some implementations, a computer system includes a memory storing instructions and one or more processors configured to execute the instructions to receive one or more estate-planning documents associated with a user, extract, from the one or more estate-planning documents, structured estate data including at least one of fiduciary role information, beneficiary information, asset-disposition information, or a reference to a related estate-planning document, store the structured estate data in association with the user, verify a death event associated with the user, and transmit, in response to verifying the death event, a notification to at least one designated recipient using at least a portion of the structured estate data stored in association with the user.

In some implementations, a computer system includes a memory storing instructions and one or more processors configured to execute the instructions to receive one or more estate-planning documents associated with a user, extract, from the one or more estate-planning documents, structured estate data including at least beneficiary information or a reference to a related estate-planning document, store the structured estate data in association with the user, verify a death event associated with the user, provide, in response to verifying the death event, at least one designated recipient access to at least a portion of at least one of the one or more estate-planning documents, and redact, prior to providing the access, personally identifiable information, protected health information, or confidential content identified from the structured estate data extracted from the one or more estate-planning documents.

In some implementations, a computer system includes a memory storing instructions and one or more processors configured to execute the instructions to receive jurisdictional data associated with a power of attorney transaction, determine, based on the jurisdictional data, an embassy or consular filing authority associated with the power of attorney transaction, receive or generate a power of attorney document, generate a filing package for the power of attorney document, validate one or more authentication features of the filing package, and submit the filing package to the embassy or consular filing authority.

In some implementations, the jurisdictional data includes at least one of a country associated with a user, a country associated with real or personal property, a country associated with an estate interest, or a country associated with a designated recipient. In some implementations, the filing package includes the power of attorney document and at least one of jurisdiction-specific metadata, embassy-specific metadata, supporting documents, user identification information, or estate-related information. In some implementations, the system detects whether a cross-border relationship exists among a filer, a property or estate interest, and one or more estate-related recipients, transmits one or more filing-related notifications in response to detecting the cross-border relationship, and stores filing status information and audit-log information associated with a filing workflow for the filing package.

In some implementations, the system further supports blockchain-based property-record workflows in which one or more blockchain-associated records are generated, stored, or managed in association with offchain property documents or interests in a property-owning entity. In some implementations, the blockchain-based property-record workflows include record anchoring, tokenized ownership tracking, compliance controls, transfer administration, or audit logging associated with real property or a property-owning entity.

These features and advantages, along with other features and advantages of the present teachings, may be readily apparent from the following detailed description of the modes for carrying out the present teaching when taken in connection with the accompanying drawings. It should be understood that even though the following figures and embodiments may be separately described, single features thereof may be combined with additional elements.

### BRIEF DESCRIPTION OF THE DRAWINGS

The accompanying drawings, which may be incorporated into and constitute a part of this specification, illustrate implementations and embodiments of the disclosure and together with the description, serve to explain the principles of the disclosure.

FIGS. 1A-1E are diagrams of an overview of an example implementation described herein.

FIG. 2 is a diagram of an example environment in which systems and/or methods, described herein, may be implemented.

FIG. 3 is a diagram of example components of one or more devices of FIG. 2.

FIGS. 4A-4B are flowcharts of an example process for automatically processing estate-planning documents and delivering posthumous notifications based on verified death of an account holder.

FIG. 5 is a flowchart of an example process for retrieving and displaying plain-language definitions of legal terms based on user interaction with estate documents.

FIG. 6 is a flowchart of an example process for generating an estate-administration form using structured estate data extracted from one or more estate-planning documents.

FIG. 7 is a flowchart of an example process for embassy or consular filing of a power of attorney document.

FIG. 8 is a flowchart of an example process for detecting a cross-border relationship and transmitting one or more filing-related notifications.

FIG. 9 is a flowchart of an example process for generating and managing blockchain-associated records corresponding to offchain property documents or interests in a property-owning entity.

### DETAILED DESCRIPTION

The following detailed description of example embodiments refers to the accompanying drawings. The same reference numbers in different drawings may identify the same or similar elements.

The process of managing estate-planning documents, notifying interested parties upon the death of an individual, and administering the decedent's estate involves numerous logistical, legal, and administrative challenges. Despite the critical importance of efficient estate administration, conventional systems and practices remain highly fragmented, manual, and error-prone.

Estate-planning documents—such as wills, trusts, powers of attorney, and advance directives—are frequently stored in disparate locations, including attorney offices, personal safes, or various online accounts. In many cases, these documents are paper-based or saved in unstructured digital formats, making them difficult to locate, access, analyze, or authenticate at the time of need. The lack of a centralized, secure, and persistent repository for such documents often results in lost or outdated records, uncertainty about the decedent's true intentions, and disputes among heirs or fiduciaries. Furthermore, even when documents are accessible, users may struggle to interpret the legal meaning or determine the relationship between multiple estate planning instruments.

Notifying beneficiaries, executors, and other designated recipients of a decedent's death is another area fraught with difficulty. Traditional notification methods rely on surviving family members or representatives to initiate contact, a process that is frequently delayed or incomplete. Many individuals who have been designated to receive documents or fulfill estate-related roles (e.g., executor or trustee) are unaware of their status and may not be reachable in a timely manner. This delay can stall the estate administration process and lead to noncompliance with legal timelines.

Verifying the death of an account holder presents further complications. Death certificates must often be submitted manually and are subject to administrative delays, clerical errors, or fraud. Although some government and private databases provide mortality data, conventional estate management systems lack integration with these resources, resulting in prolonged verification timelines and potential misuse of sensitive data if adequate safeguards are not in place. Furthermore, the manual review of death data and associated documents places a burden on administrators and can lead to delays in notification and document release.

The estate administration process itself is often hindered by the lack of immediate access to authenticated planning documents, the absence of analysis tools that can distill legal meaning, and the absence of role-based frameworks that guide authorized individuals through posthumous processes. Executors and administrators may face delays in initiating probate proceedings or transferring assets due to incomplete records or legal uncertainty. Without tools to interpret legal provisions and determine document interrelationships, fiduciaries may misinterpret the decedent's instructions or overlook important clauses. The challenge is further compounded by the need to maintain privacy and regulatory compliance when disseminating sensitive content to authorized recipients.

Conventional estate management solutions also fail to offer context-aware legal guidance. Users encountering complex legal terms or clauses must seek external advice, increasing costs and delays. Likewise, there is a lack of intelligent redaction tools that allow sensitive information—such as personally identifiable information (PII), protected health information (PHI), and confidential business data—to be obscured or selectively revealed based on authentication, consent, or regulatory requirements.

As a result, a computer-implemented platform (referred to as the “Estate Notification and Document Platform” or “platform”) is provided. The platform comprises a plurality of integrated modules configured to facilitate registration, secure document storage, document analysis, legal interpretation, death verification, redaction, notification, and legal form generation. The platform enables an account holder (i.e., user) to register, upload estate-planning documents, and designate individuals to receive notifications and documents upon the account holder's death. A user interface module provides the interaction layer for account setup, document management, and assignment of roles or notification preferences. A document processing module uses artificial intelligence (AI) to extract, verify, and structure key data from legal documents (e.g., wills, trusts, powers of attorney) and store that data in a secure and standardized format.

A document analysis module further processes the uploaded documents to generate summaries, identify document-to-document relationships, and surface legal provisions, fiduciary roles, and asset distributions to assist users and administrators in understanding the scope and function of each document individually and collectively.

A legal term module enhances document comprehension by dynamically providing plain-language definitions of legal terms encountered in the documents. These definitions may be retrieved from a glossary database or generated contextually via an artificial intelligence engine using surrounding text.

A redaction module enables administrators to selectively obscure or remove sensitive content (e.g., PII, PHI, or confidential business data) from documents before release to beneficiaries, executors, or other third parties. Redactions may be applied manually or programmatically, with the option to lift redactions based on biometric authentication, two-factor authentication (2FA), or administrator approval.

The death verification module confirms the death of an account holder by querying one or more mortality databases or by authenticating an uploaded death certificate. Upon successful verification, a notification module triggers alerts to designated individuals via email, SMS, or voice communication, with optional delay periods or administrator approvals configurable at the user level.

A form generator module uses structured data extracted from estate-planning documents to populate estate-administration forms such as small estate affidavits, transfer-on-death deeds, and affidavits of domicile, which can then be previewed, finalized, and delivered through the platform.

The platform supports role-based access control, audit logging, delayed notification triggers, and administrator-controlled workflows, providing a secure, intelligent, and flexible infrastructure for managing estate-related documentation and posthumous communications.

In some implementations, the platform also supports blockchain-based property-record workflows associated with offchain property documents, property-owning entities, or tokenized ownership interests. For example, the platform may generate, store, manage, or transmit one or more blockchain-associated records corresponding to deeds, title-related records, transfer records, entity records, ownership records, or other property-related records, as discussed in greater detail below.

The Estate Notification and Document Platform provides several technical improvements over conventional estate administration tools. By employing artificial intelligence to extract, structure, and analyze estate-planning documents, the platform reduces the computational burden associated with manual parsing, classification, and legal review of complex, unstructured documents. The platform's modular architecture distributes document-processing, verification, notification, redaction, filing, and record-management operations across computing resources and supports reuse of structured data across downstream workflows; thereby reducing memory usage, input/output overhead, and data retrieval latency.

The legal term module improves user interaction and reduces reliance on external lookups by dynamically retrieving or generating plain-language definitions contextually, thereby enhancing real-time comprehension without interrupting the workflow. The redaction module enables targeted, automated data filtering that reduces the need for redundant document copies or duplicate processing tasks, further minimizing storage demands and processing cycles.

Additionally, by automating death verification through database integration and AI-based document authentication, the platform avoids unnecessary polling operations, minimizes user intervention, and reduces transaction load on backend servers. The system also improves data integrity and compliance through secure access controls, structured audit logging, and conditional logic to trigger downstream operations (e.g., notifications or form generation) based on verified events.

Collectively, these implementations enable more secure and efficient handling of estate-related documents by reducing repeated manual review, transforming unstructured estate-planning documents into structured estate data reusable across multiple workflows, and supporting event-triggered operations including notification, controlled document access, filing workflows, and audit logging. These implementations provide practical computer-implemented techniques for managing estate-related records, documents, and communications in a manner that improves data consistency, workflow coordination, and access control across the platform.

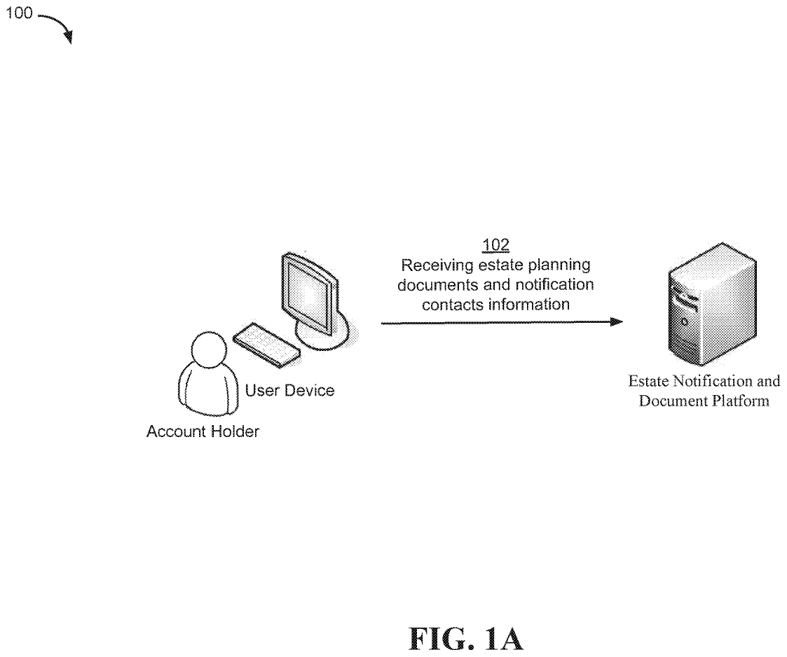

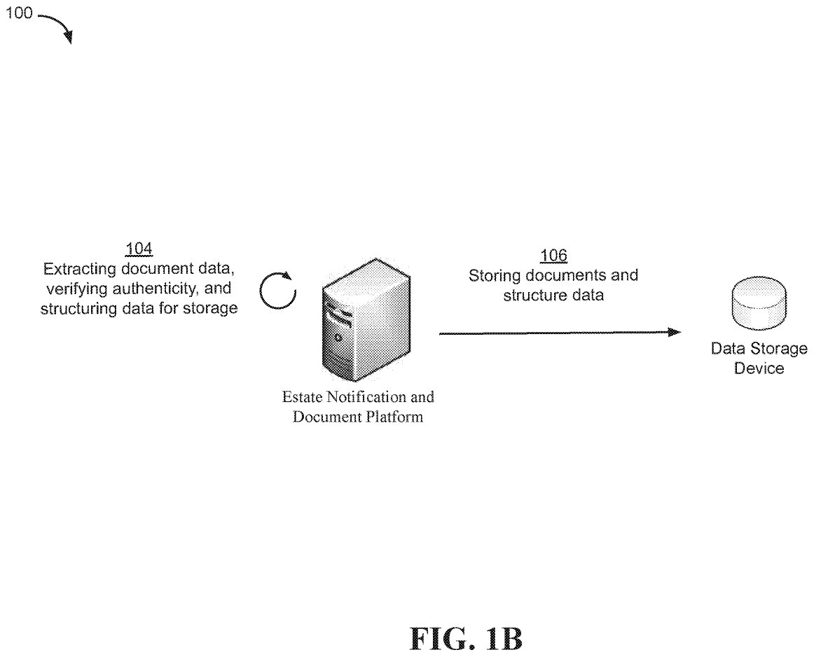

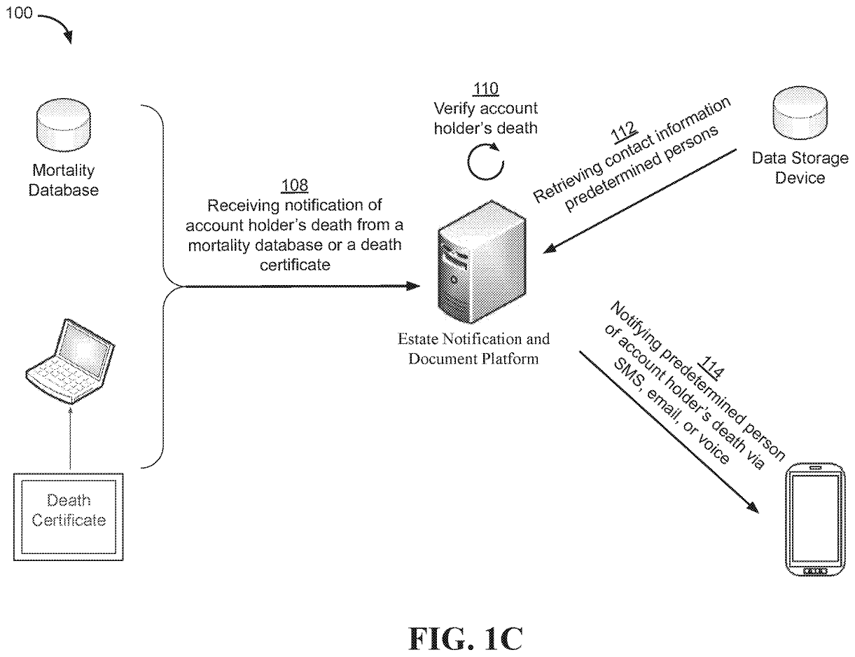

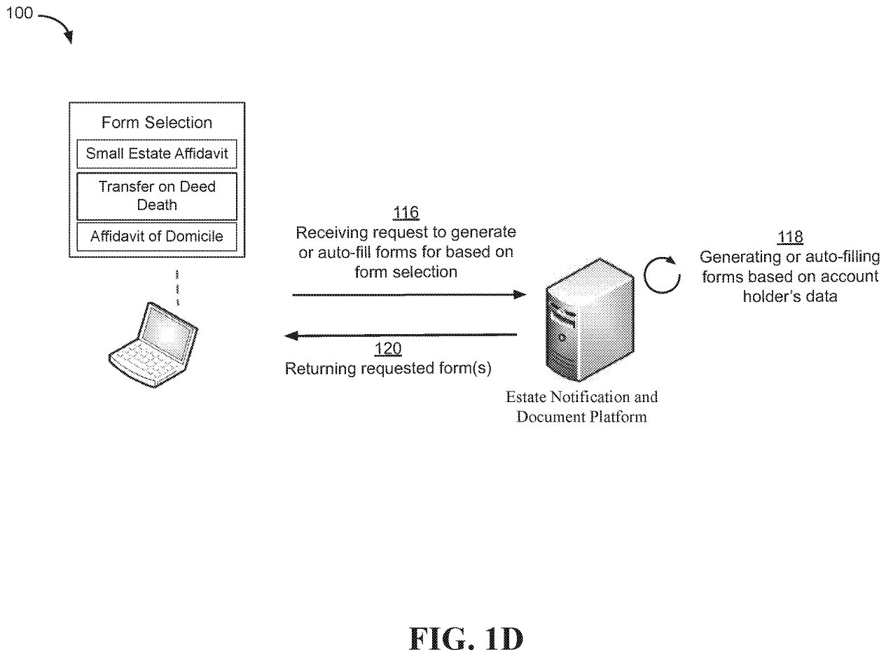

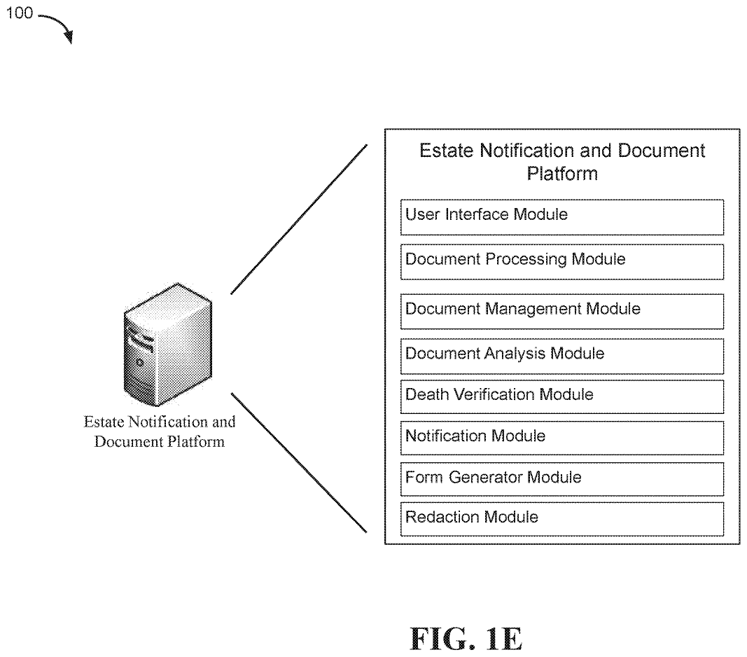

FIGS. 1A-1E are diagrams of one or more example implementations 100 described herein. As shown in FIGS. 1A-1E, example implementation(s) 100 may include an estate notification and document platform. In some implementations, example implementations(s) 100 may include a user device, a data storage device, and/or other devices.

The estate notification and document platform provides a computer-implemented system configured to manage estate-related documents and posthumous communications. The platform enables account holders to register and upload estate-planning documents and estate-related documents, designate beneficiaries and third-party roles, and specify notification preferences. Utilizing artificial intelligence, the platform extracts key data from documents, verifies their authenticity, and structures the data for secure storage. Upon the death of an account holder, the platform verifies the death using automated database checks and/or manual certificate review, and triggers notifications to designated recipients. The platform may also generate pre-filled estate-administration forms based on the extracted data to support estate settlement activities.

As shown in FIG. 1A, and by reference number 102, the platform is configured to receive estate-planning documents and contact information from designated recipients via a user device operated by a user (i.e., account holder). In some implementations, account holders are required to register on the platform in order to upload estate-planning documents and related documents and to provide contact information for designated recipients (i.e., predetermined persons) of posthumous communications.

As shown in FIG. 1B, and by reference number 104, the platform is configured to extract data from the uploaded documents, verify the authenticity of the uploaded documents, and extract data for storage on a data storage device. Non-limiting examples of extracted data include:
Full legal names of parties (e.g., testator, trustee, beneficiaries, executors);
Dates of execution, expiration, or triggering events (e.g., death, incapacity);
Fiduciary roles and responsibilities (e.g., personal representative powers, successor trustees);
Disposition of assets (e.g., specific bequests, residuary gifts, real property descriptions);
Legal clauses or directives (e.g., revocation language, survivorship conditions, tax allocation);
Healthcare instructions (e.g., medical directives, organ donation);
Definitions of terms used in the documents;
Witness and notary information; and
References to related documents (e.g., pour-over wills referencing revocable trusts).

In some implementations, artificial intelligence (AI) is used to analyze and extract data from the documents. An AI engine may employ a combination of:
Optical Character Recognition (OCR), such as AWS Textract, to convert image-based or scanned documents into machine-readable text;
Natural Language Processing (NLP) algorithms, such as those provided by Loveable. AI, to identify named entities, roles, and relationships;
Document classification models to distinguish between types of documents (e.g., will, power of attorney, trust, medical directive);
Semantic parsing models to interpret legal provisions and extract actionable content (e.g., identifying that a clause assigns durable financial power of attorney to a named individual).

For example, when a user uploads a revocable trust, the AI may extract the name of the settlor, the initial trustee, successor trustee(s), names and conditions of beneficiaries, and any provisions relating to amendments or revocation. The structured output is then formatted in a standardized schema (e.g., JSON, XML) and stored securely in the data storage device in association with the account holder's profile.

This structured and authenticated data may be later used by downstream modules such as the notification module (to identify appropriate recipients), the form generator module (to populate legal filings), and the redaction module (to detect and classify sensitive fields for privacy protection). FIG. 1E discusses the notification module, form generator module, and redaction module in greater detail.

As further shown in FIG. 1B by reference number 106, the platform is configured to store documents and the extracted data for the documents.

As shown in FIG. 1C and indicated by reference numeral 108, the platform may receive notification of the account holder's death from a mortality database, a death certificate, or a combination thereof. In the case of a mortality database, the platform may be configured to automatically receive death notification data through data transmission protocols including, but not limited to, Application Programming Interfaces (APIs), webhooks, polling the mortality database, secure file transfer protocols (SFTP), or Hypertext Transfer Protocol Secure (HTTPS) endpoints. Such transmissions may occur directly between the platform and one or more mortality databases, or indirectly through intermediary servers or data aggregators in communication with such databases. The system may support push-based notifications (initiated by the database) or pull-based requests (initiated by the platform), or a combination thereof. The mortality databases may include public or governmental sources (e.g., Social Security Death Master File), private third-party data providers, or federated networks that consolidate mortality data from multiple sources. In some embodiments, authentication tokens, encryption layers, or secure access credentials may be employed to ensure data integrity and privacy compliance during transmission.

In the case of a death certificate, the platform is configured to receive a manually uploaded death certificate from a third party, such as a family member, executor, or designated administrator. The death certificate may be uploaded through the user interface module (discussed below in greater detail in FIG. 1E) via a secure file upload mechanism that supports various formats, including PDF, JPEG, PNG, or TIFF.

As further shown in FIG. 1C and indicated by reference numeral 110, upon receipt of the death certificate, the platform may verify the account holder's death by performing authenticity checks of the death certificate via a document processing module (discussed below in greater detail in FIG. 1E). These checks may include analysis of visual features (e.g., seals, signatures, official letterhead), metadata extraction, and comparison against known templates.

In some implementations, the death certificate may also be routed to an account holder administrator or verification agent for manual review and approval prior to triggering any downstream processes, including activation of the notification module (discussed below in greater detail in FIG. 1E) or release of stored documents to predetermined persons.

As further shown in FIG. 1C and indicated by reference numeral 112, the platform may retrieve the contact information of the designated recipients (i.e., predetermined persons) from the data storage device after verifying the account holder's death. The contact information may include name, telephone numbers (i.e., mobile numbers), physical addresses, email addresses, and social media information of a predetermined person.

As further shown in FIG. 1C and indicated by reference numeral 114, the platform may notify one or more predetermined persons of the account holder's death via the notification module (discussed below in greater detail in FIG. 1E). The notification may be in the form of SMS, email, voice, or combination thereof. In some implementations, the predetermined person may continue to receive notification until the predetermined person acknowledges receipt of the notification. In some implementations, the predetermined person may receive a predetermined number of notifications.

As shown in FIG. 1D and indicated by reference numeral 116, the platform may receive a request to generate or auto-fill forms based on form selection via a user device by a third-party, such as a family member, executor, or designated administrator. The form selection allows the third-party to request the creation of a Small Estate Affidavit, Transfer on Deed Death, Affidavit of Domicile, and/or the like.

As further shown in FIG. 1D and indicated by reference number 118, the platform may generate or auto-file forms based on account holder's data via the form generator module (discussed below in greater detail in FIG. 1E) after receiving the third-party request.

As further shown in FIG. 1D and indicated by reference number 120, the platform may return the generated forms to the user device for the third-party. The generated forms may be in various formats, such including PDF, JPEG, PNG, or TIFF.

FIG. 1E shows the various modules that the estate notification and document platform is configured to implement. In some implementations, the platform includes a user interface module, a document processing module, a document management module, a death verification module, a notification module, and a form generator module.

The user interface module enables a user device to interact with the platform. Through this module, an account holder may register an account and input estate-related data such as beneficiary names, executor or administrator designations, and contact details for one or more predetermined persons designated to receive notifications and documents upon the account holder's death. The user may upload documents, update information, or remove previously stored documents. In some implementations, the user may grant role-based access to third parties, such as assigning a “beneficiary and asset designation manager” authorized to manage digital assets or a “platform administrator” authorized to review death certificates and confirm or override verification results.

The following is an example implementation of the user interface module. An account holder registers on the platform and designates her daughter and brother as beneficiaries, uploads a will, and selects her attorney as a predetermined person to receive a death notification and selected documents.

The document processing module utilizes artificial intelligence to automate the extraction of document details, verification of authentication, and structuring of data for storage. The module may rely on one or more document-processing services or engines for optical character recognition, document authenticity verification, document classification, semantic understanding, or combinations thereof. Non-limiting examples of the document-processing services or engines may include external services such as AWS Textract for document OCR, Ready Redact for document authenticity verification, and Loveable. AI for document classification and semantic understanding. Documents processed may include, without limitation, last wills and testaments, powers of attorney (including healthcare, financial, and durable forms), trust instruments (e.g., revocable and irrevocable), certificates of trust, HIPAA authorization forms, medical directives, living wills, personal and business asset assignments, and deeds.

The following is an example implementation of the document processing module. A user uploads a revocable living trust. The document processing module extracts grantor and trustee names, trust formation date, and key provisions, verifies its digital signature, and stores the data in structured format.

The document analysis module is configured to analyze documents individually and collectively. The document analysis module may provide insights, details, and summaries of the information contained within an individual document. The document analysis module may provide insights, details, and summaries of a collection of documents and may provide the relationship between documents and among the collection of documents. The following are example implementations of the document analysis module.
Example 1: Upon analyzing a will, the module summarizes: three beneficiaries (by name), specific assets to each, a per stirpes distribution method, and the powers granted to the executor.
Example 2: When analyzing a document set, the module identifies that a revocable trust and a pour-over will reference each other, ensuring the user's assets are covered posthumously and clarifying document relationships.

The legal term module is configured to assist users in understanding legal terminology found within estate-planning documents or other materials displayed on the estate notification and document platform. The legal term module provides plain-language definitions of legal terms in real time, improving accessibility and comprehension for non-lawyers (i.e., users who may lack legal training) engaging with complex estate-related documents. The definitions may be sourced from a legal glossary, dynamically generated using AI-based summarization, user-supplied definitions, or any combination thereof.

In some implementations, when a legal term is displayed on the graphical user interface (GUI) of a user device, the estate notification and document platform is configured to detect user interaction with the term. For instance, when a user hovers over, clicks on, or taps on a displayed legal term, the platform initiates a term definition request.

In one implementation, when the user hovers over a legal term presented via the GUI on the user device, the user device transmits a request to a backend server of the Estate Notification and Document Platform via an application programming interface (API). This request includes:
the legal term, and
the contextual text associated with the term (e.g., a sentence or paragraph in which the term appears).

The server receives the request and determines whether the legal term is stored in a local or remote legal definition database (i.e., data storage device). If the term is found, the Estate Notification and Document Platform retrieves the predefined definition and returns it to the user device.

If the legal term is not found in the database, the platform transmits the legal term and its associated context to an artificial intelligence engine. The AI engine may comprise a large language model (LLM) or similar semantic processing system capable of generating contextual, human-readable legal definitions. The AI engine uses the surrounding text to interpret the legal usage and generate a contextually relevant definition.

Once generated, the AI engine returns the contextual definition to the backend server. The server then forwards the definition to the user device, where it is displayed as a tooltip, pop-up, or side-panel glossary entry adjacent to the legal term.

The following is an example use case of the legal term module. For example, if a user reads a clause from a will stating: “I give the rest, residue, and remainder of my estate to my children in equal shares, per stirpes.”

Upon hovering over the term “per stirpes,” the following steps occur:
1. The user device transmits the term “per stirpes” and the surrounding clause to the backend server of the Estate Notification and Document Platform.
2. The platform checks the legal term database and determines the term is not defined therein.
3. The platform transmits the request to the AI engine.
4. The AI engine returns the definition: “Per stirpes” is a legal term meaning that if a beneficiary predeceases the testator, that beneficiary's share will pass to their descendants in equal parts.
5. The server returns the definition to the user computer, where it is displayed as a tooltip.
The document management module enables account holders to organize and manage documents stored in a secure library. The system may support tagging, metadata assignment, version control, and access permissions to facilitate structured storage and easy retrieval.

The following is an example implementation of the document management module. A user tags uploaded powers of attorney and HIPAA releases as “healthcare,” sets expiration alerts, and grants view-only access to their healthcare proxy.

In some implementations, the document management module and related storage workflows may also support blockchain-based property records and tokenized ownership structures associated with real property or property-owning entities. As used herein, a “blockchain-associated record” may include a hash, metadata record, digital certificate, token, registry reference, or other record associated with a blockchain-based system and corresponding to one or more offchain property documents, entity records, ownership records, or workflow records.

In some implementations, the platform further supports blockchain-based workflows associated with real property, property-related records, or interests in a property-owning entity. In some implementations, the platform stores, generates, manages, or transmits one or more blockchain-associated records corresponding to one or more offchain property documents, title-related records, transfer records, entity records, or ownership records.

In some implementations, the offchain property documents include one or more deeds, title reports, title policies, surveys, mortgage documents, lien records, lease documents, homeowner-association records, trust records, entity-formation documents, operating agreements, transfer documents, or other records associated with real property or a property-owning entity. In some implementations, the platform generates one or more hashes, metadata records, digital certificates, registry references, or other blockchain-associated records corresponding to the offchain property documents.

In some implementations, the platform supports a record-anchoring workflow in which one or more blockchain-associated records are used as tamper-evident references to one or more offchain property documents. For example, the platform may store one or more document hashes, registry references, workflow states, approval states, maintenance records, rent-distribution records, ownership-administration records, or other administrative records in association with a blockchain-based record while maintaining one or more corresponding property documents offchain. In some implementations, the platform stores one or more rules indicating that a recorded deed, registry record, or other official offchain property record controls legal title in the event of a conflict with a blockchain-associated record.

In some implementations, the platform supports tokenization of an entity that owns real property. For example, real property may be owned by a limited liability company, special purpose vehicle, trust, corporation, partnership, or another entity, and the platform may generate, manage, transfer, track, or report one or more tokens associated with shares, membership interests, beneficial interests, or other interests in the entity. In some implementations, the platform maintains one or more issuer records, transfer-agent records, cap-table records, investor-whitelist records, distribution records, consent records, or ownership records associated with the tokenized entity interests.

In some implementations, the platform uses one or more smart contracts or programmable logic modules to enforce one or more transfer restrictions, whitelist one or more approved holders, track ownership changes, manage approvals, administer distributions, manage rent waterfalls, manage maintenance workflows, or manage investor reporting. In some implementations, the platform further stores or generates compliance data associated with securities restrictions, anti-money-laundering restrictions, know-your-customer restrictions, tax reporting, jurisdictional restrictions, or combinations thereof.

In some implementations, the platform supports a registry-integration workflow in which one or more blockchain-associated records are synchronized with, referenced by, or otherwise associated with a governmental land registry, recorder's office, title system, or other public property-record system. In some implementations, the degree of legal effect associated with a blockchain-based record depends on one or more jurisdiction-specific rules, regulations, registry practices, recorder requirements, or statutory recognition frameworks.

In some implementations, the platform performs a blockchain-associated property-record workflow by receiving one or more offchain property documents, determining one or more records to be represented onchain, generating one or more hashes or blockchain-associated references corresponding to the offchain property documents, storing associations between the blockchain-associated references and the offchain property documents, generating one or more tokens or digital records associated with the property or a property-owning entity, applying one or more permission, compliance, or transfer-control rules, and updating one or more workflow records based on transfers, approvals, distributions, financing events, or reporting events. This process tokenizes the real property onchain converting it into a Real World Asset (RWA). RWA refers to tangible assets that exist outside the digital realm. These can range from bonds to real estate properties, commodities, and machinery. Nonlimiting examples of RWA include debentures, treasury bills, government bonds, artwork, wine, vehicle ownership documents, stocks and bonds, deeds of real property, and intellectual property.

In some implementations, before generating one or more blockchain-associated records, the platform receives and stores one or more current title, lien, mortgage, lease, or ownership records associated with the property or property-owning entity. In some implementations, the blockchain-associated records are used for document integrity, workflow management, auditability, transfer administration, investor access, capital formation, cap-table administration, distribution workflows, compliance controls, collateralization workflows, financing workflows, estate planning, probate-related administration, transfer-related administration, or combinations thereof.

In some implementations, the platform also uses structured records, document verification workflows, and downstream access controls in connection with death verification, posthumous notification, and other estate-administration processes described below.

The death verification module is configured to confirm the account holder's death through automated or manual methods. Verification may include querying third-party public databases or uploading a death certificate. Submitted certificates may be verified through one or more document-authentication services. A non-limiting example of document-authentication service includes Ready Redact. In some cases, confirmation from a designated administrator is required before subsequent notifications are triggered.

The following is an example implementation of the death verification module. A platform administrator uploads a certified death certificate. The platform validates the death certificate via a validation algorithm, such as Ready Redact, and routes it to the administrator for final confirmation before notifications are sent.

Upon successful verification, the notification module is activated. The system may automatically notify one or more predetermined persons, as previously designated by the account holder. Notifications may be transmitted via email, SMS, or voice call, and may include delivery of selected documents. The module may incorporate a delay or approval workflow, requiring confirmation from an administrator before release.

The following is an example implementation of the notification module. Two days after the verified death of an account holder, the notification module sends an email and SMS to the designated attorney and spouse with access links to selected documents, where the email and SMS reads: “The estate of John Doe has entered posthumous status. Please access the platform to review instructions and documents.”

The form generator module is configured to produce estate-administration forms using data extracted from uploaded documents. The module may automatically generate and pre-fill forms such as powers of attorney, small estate affidavits, transfer-on-death deeds, affidavits of domicile, and/or the like. Generated forms may be previewed, edited, and finalized within the platform. The generated forms may be in English or various languages. Various languages include, but are not limited to, Mandarin Chinese, Hindi, Spanish, Standard Arabic, French, Bengali, Portuguese, and Russian

The following are example implementations of the form generator module.
Example 1: The system auto-generates a small estate affidavit using information from the decedent's uploaded will and trust (e.g., the decedent's name, date of death, heirs, and property descriptions). The user previews the form before signing and downloading it.
Example 2: The system auto-generates forms necessary to file with a designated international consulate and provide executed Power of Attorney documents to a designated recipient. The forms are auto-generated using information from the account holder's account on the Estate Notification and Document Platform.

In some implementations, an international consulate filing workflow includes embassy or consular routing, filing-package generation, validation of filing-package authentication features, embassy or consular submission, cross-border relationship detection, notification to one or more estate-related recipients, and status tracking with audit logging. The international consulate filing workflow is discussed below in greater detail.

The redaction module is configured to allow an administrator to selectively obscure, redact, or remove sensitive content from estate-related documents and other documents uploaded to the Estate Notification and Document Platform prior to transmission to one or more predetermined persons. The administrator may grant a person, selected persons, or a class of persons access to documents that are unredacted or partially redacted.

The redaction module supports role-based unredacting. In some implementations, the redaction module may remove redactions after a predetermined person is verified with biometrics authentication, two-factor authentication (2FA), or a combination thereof. Non-limiting examples of biometric authentication methods include fingerprinting scanning, facial recognition, iris scanning, voice recognition, retinal scanning, behavioral biometrics (e.g., typing patterns), and/or the like. Non-limiting examples of 2FA methods include SMS verification, authenticator apps, security keys, push notifications, one-time passwords (OTPs), time-based one-time passwords (TOTP), and/or the like.

Documents may be redacted for information associated with personally identifiable information (PII). Non-limiting examples of PII include social security numbers, taxpayer identification, names of minors, dates of birth, home addresses, financial account numbers, maiden names, and/or the like.

Documents may be redacted for information associated with protected health information (PHI). Non-limiting examples of PHI includes medical records (e.g., any information related to an individual's medical history or treatment should be redacted), mental health information (e.g., redact details that could reveal someone's identity as receiving mental health services), substance use disorder information (e.g., protect individuals receiving or under evaluation for substance use disorder services).

Documents may be redacted for information associated with confidential information. Non-limiting examples of confidential information include intellectual property (e.g., trade secrets, confidential business information, and copyrighted materials should be redacted), sensitive business information (e.g., financial details, customer lists, and proprietary information) and trade secrets (e.g., protect commercially valuable, confidential information).

The following are example implementations of the redaction module.
Example 1: A will includes the names and birthdates of minors. The administrator redacts this personally identifiable information (PII) for recipients outside the immediate family.
Example 2: A business partner receives a redacted version of a buy-sell agreement that hides confidential financial details until identity is verified via fingerprint scan and OTP.

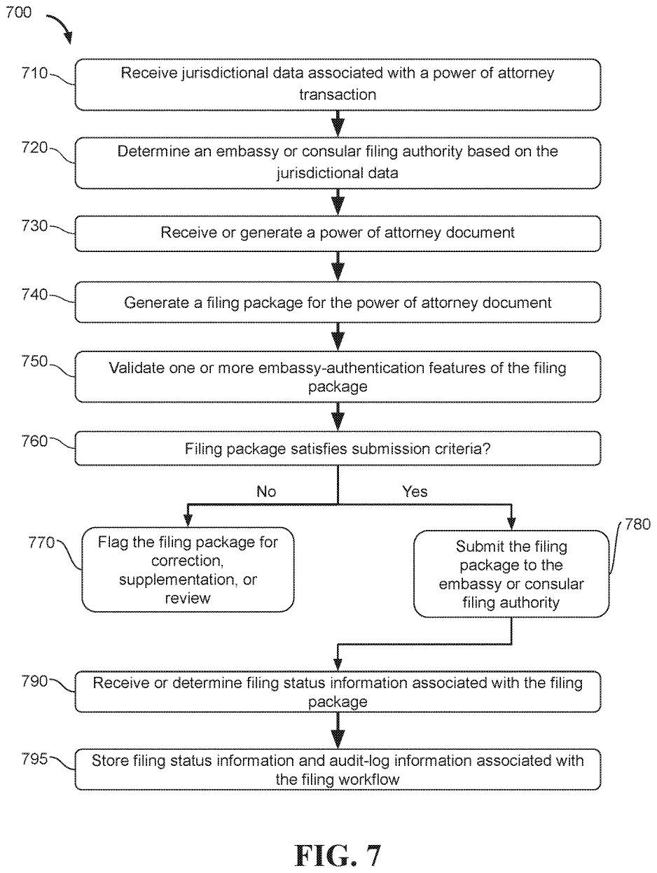

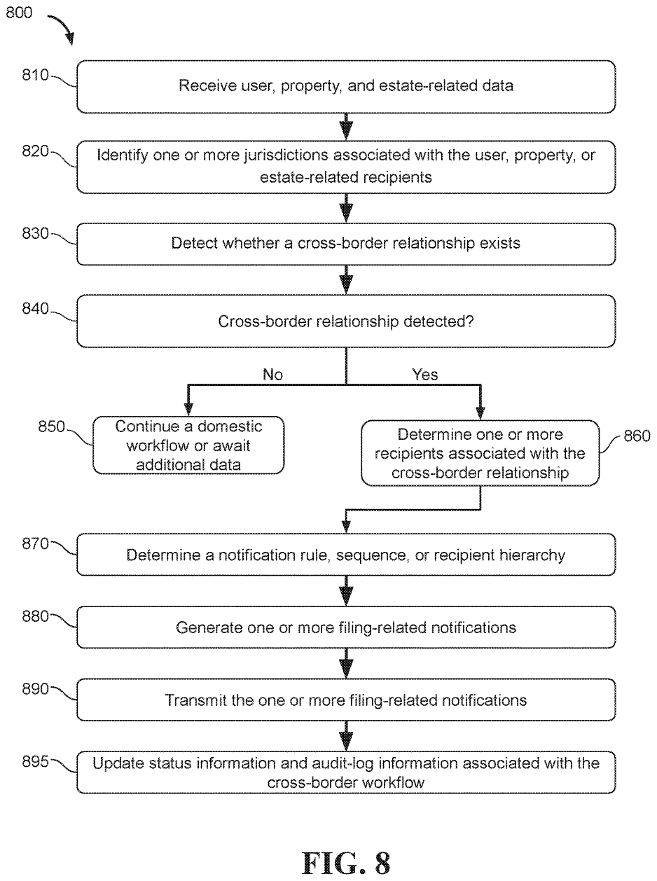

In some implementations, as briefly mentioned above and discussed in greater detail in FIGS. 7 and 8, the international consulate filing workflow includes embassy or consular routing, filing-package generation, validation of filing-package authentication features, embassy or consular submission, cross-border relationship detection, notification to one or more estate-related recipients, and status tracking with audit logging.

In some implementations, the platform includes a cross-border estate authority routing and notification engine configured to receive jurisdictional data associated with a power of attorney transaction. The jurisdictional data may include one or more of a country associated with a user, a country associated with real or personal property, a country associated with one or more beneficiaries, and identity information for one or more executors, heirs, beneficiaries, co-owners, trustees, or other designated recipients.

In some implementations, the platform determines an embassy or consular filing authority based on the jurisdictional data. The platform may apply one or more jurisdiction-specific rules, mappings, or lookup tables to determine a filing path for a power of attorney document.

In some implementations, the platform generates a filing package for the power of attorney document. The filing package may include the power of attorney document, jurisdiction-specific metadata, embassy-specific metadata, supporting documents, user identification information, estate-related information, and other filing data associated with the determined filing authority.

In some implementations, the platform validates one or more embassy-authentication features of the filing package before submission. Validation may include seal detection, signature verification, signature embeddings, anomaly detection, document-integrity analysis, or image analysis.

In some implementations, after validation, the platform submits the filing package to the embassy or consular filing authority. After submission, the platform may detect a cross-border relationship among a filer, one or more relevant properties or estate interests, and one or more estate-related recipients. In response to detecting the cross-border relationship, the platform may transmit one or more notifications to one or more designated recipients and may store status information and audit-log information associated with the filing workflow.

In some implementations, documents, filing records, and submission-related materials associated with the embassy or consular workflow may also be processed by one or more downstream document-control modules of the Estate Notification and Document Platform, including modules configured to restrict access to sensitive content before transmission to one or more designated recipients.

As indicated above, FIGS. 1A-1E are provided merely as examples. Other examples are possible and may differ from what was described with regard to FIGS. 1A-1E.

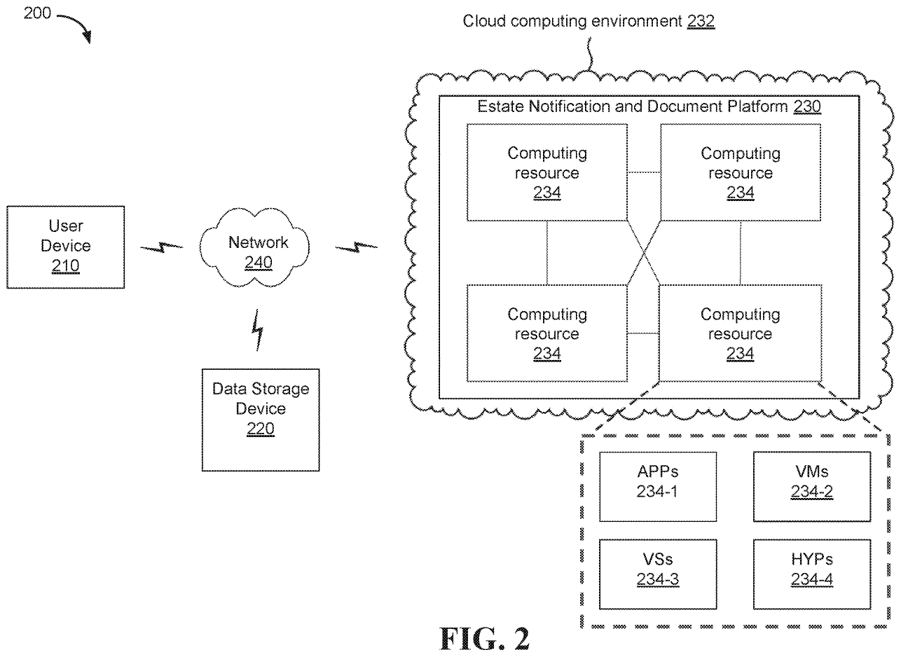

FIG. 2 is a diagram of an example environment 200 in which systems and/or methods, described herein, may be implemented. As shown in FIG. 2, environment 200 may include a set of user devices 210 (e.g., referred to collectively as “user devices 210” and individually as “user device 210”), a set of data storage devices 220 (e.g., referred to collectively as “data storage devices 220” and individually as “data storage device 220”), estate notification and document platform 230 in cloud computing environment 232 that includes a set of computing resources 234, and network 240. Devices of environment 200 may interconnect via wired connections, wireless connections, or a combination of wired and wireless connections.

User device 210 includes one or more devices capable of receiving, generating, storing, processing, and/or providing information, such as information described herein. For example, user device 210 may include a mobile phone (e.g., a smart phone, a radiotelephone, etc.), a laptop computer, a tablet computer, a handheld computer, a gaming device, a wearable communication device (e.g., a smart wristwatch, a pair of smart eyeglasses, etc.), a desktop computer, a set-top box, or a similar type of device. In some implementations, user device 210 may provide, to estate notification and document platform 230, estate-planning documents, estate-related data, notification preferences, recipient information, jurisdictional data, property-related data, or other information described herein. Additionally, or alternatively, user device 210 may receive, from estate notification and document platform 230, notifications, document-access links, generated forms, filing-status information, audit information, or other outputs described herein.

Data storage device 220 includes one or more devices capable of receiving, storing, and/or providing information, such as information described herein. For example, data storage device 220 may include a hard disk drive (HDD), a solid state drive (SSD), network attached storage, a storage array (e.g., a redundant array of independent disks (RAID) and/or another type of storage array), a storage server, a cloud storage deployment, a non-volatile memory device, or a similar type of device. In some implementations, data storage device 220 may implement and provide a data store that may be accessed by user device 210 and/or estate notification and document platform 230. In some implementations, the data store may store estate-planning documents associated with one or more users, financial information and credentials associated with one or more users, contact information of one or more predetermined persons, and/or the like. In some implementations, data storage device 220 may provide estate-planning documents, financial information and credentials, contact information of predetermined persons, and/or the like to estate notification and document platform 230 (e.g., based on receiving a request for the data from estate notification and document platform 230).

Estate notification and document platform 230 includes one or more devices capable of receiving, generating, storing, processing, and/or providing information, such as information described herein. For example, estate notification and document platform 230 may include a cloud server or a group of cloud servers. In some implementations, estate notification and document platform 230 may be designed to be modular such that certain software components can be swapped in or out depending on a particular need. As such, estate notification and document platform 230 may be easily and/or quickly reconfigured for different uses.

In some implementations, as shown, estate notification and document platform 230 may be hosted in cloud computing environment 232. Notably, while implementations described herein describe estate notification and document platform 230 as being hosted in cloud computing environment 232, in some implementations, estate notification and document platform 230 may not be cloud-based (i.e., may be implemented outside of a cloud computing environment) or may be partially cloud-based.

Cloud computing environment 232 includes an environment that hosts estate notification and document platform 230. Cloud computing environment 232 may provide computation, software, data access, storage, and/or other services that do not require end-user knowledge of a physical location and configuration of a system and/or a device that hosts estate notification and document platform 230. As shown, cloud computing environment 232 may include a group of computing resources 234 (referred to collectively as “computing resources 234” and individually as “computing resource 234”).

Computing resource 234 includes one or more personal computers, workstation computers, server devices, or another type of computation and/or communication device. In some implementations, computing resource 234 may host estate notification and document platform 230. The cloud resources may include compute instances executing in computing resource 234, storage devices provided in computing resource 234, data transfer devices provided by computing resource 234, etc. In some implementations, computing resource 234 may communicate with other computing resources 234 via wired connections, wireless connections, or a combination of wired and wireless connections.

As further shown in FIG. 2, computing resource 234 may include a group of cloud resources, such as one or more applications (“APPs”) 234-1, one or more virtual machines (“VMs”) 234-2, one or more virtualized storages (“VSs”) 234-3, or one or more hypervisors (“HYPs”) 234-4.

Application 234-1 includes one or more software applications that may be provided to or accessed by one or more devices of environment 200. Application 234-1 may eliminate a need to install and execute the software applications on devices of environment 200. For example, application 234-1 may include software associated with estate notification and document platform 230 and/or any other software capable of being provided via cloud computing environment 232. In some implementations, one application 234-1 may send/receive information to/from one or more other applications 234-1, via virtual machine 234-2.

Virtual machine 234-2 includes a software implementation of a machine (e.g., a computer) that executes programs like a physical machine. Virtual machine 234-2 may be either a system virtual machine or a process virtual machine, depending upon use and degree of correspondence to any real machine by virtual machine 234-2. A system virtual machine may provide a complete system platform that supports execution of a complete operating system (“OS”). A process virtual machine may execute a single program, and may support a single process. In some implementations, virtual machine 234-2 may execute on behalf of a user (e.g., a user of user device 210), and may manage infrastructure of cloud computing environment 232, such as data management, synchronization, or long-duration data transfers.

Virtualized storage 234-3 includes one or more storage systems and/or one or more devices that use virtualization techniques within the storage systems or devices of computing resource 234. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 234-4 provides hardware virtualization techniques that allow multiple operating systems (e.g., “guest operating systems”) to execute concurrently on a host computer, such as computing resource 234. Hypervisor 234-4 may present a virtual operating platform to the guest operating systems, and may manage the execution of the guest operating systems. Multiple instances of a variety of operating systems may share virtualized hardware resources.

Network 240 includes one or more wired and/or wireless networks. For example, network 240 may include a cellular network (e.g., a long-term evolution (LTE) network, a code division multiple access (CDMA) network, a 3G network, a 4G network, a 5G network, or another type of cellular network), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, and/or the like, and/or a combination of these or other types of networks.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

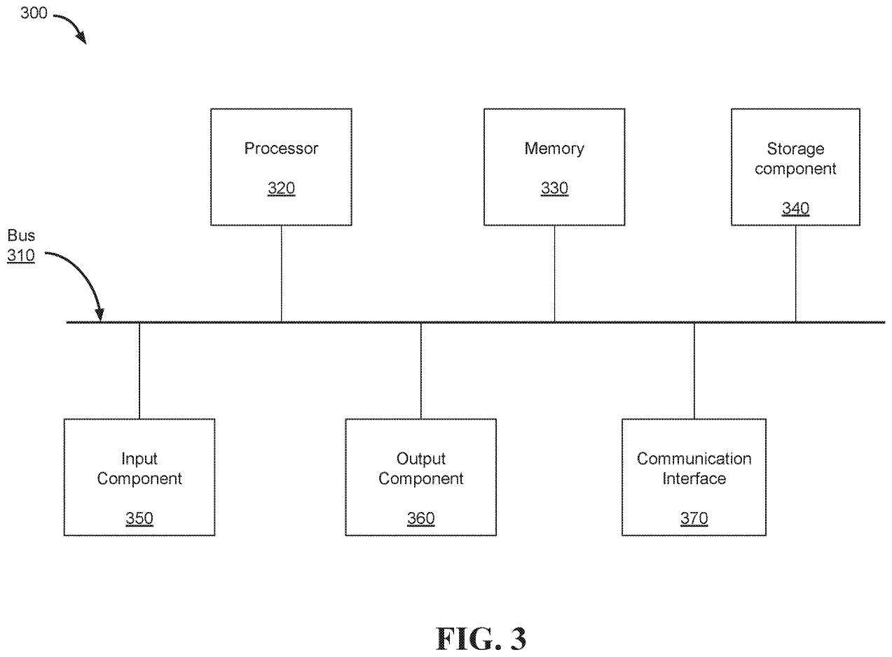

FIG. 3 is a diagram of example components of a device 300. Device 300 may correspond to user device 210, data storage device 220, estate notification and document platform 230, and/or computing resource 234. In some implementations, user device 210, data storage device 220, estate notification and document platform 230, and/or computing resource 234 may include one or more devices 300 and/or one or more components of device 300. As shown in FIG. 3, device 300 may include a bus 310, a processor 320, a memory 330, a storage component 340, an input component 350, an output component 360, and a communication interface 370.

Bus 310 includes a component that permits communication among the components of device 300. Processor 320 is implemented in hardware, firmware, or a combination of hardware and software. Processor 320 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 320 includes one or more processors capable of being programmed to perform a function. Memory 330 includes a random access memory (RAM), a read only memory (ROM), and/or another type of dynamic or static storage device (e.g., a flash memory, a magnetic memory, and/or an optical memory) that stores information and/or instructions for use by processor 320.

Storage component 340 stores information and/or software related to the operation and use of device 300. For example, storage component 340 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

Input component 350 includes a component that permits device 300 to receive information, such as via user input (e.g., a touch screen display, a keyboard, a keypad, a mouse, a button, a switch, and/or a microphone). Additionally, or alternatively, input component 350 may include a sensor for sensing information (e.g., a global positioning system (GPS) component, an accelerometer, a gyroscope, and/or an actuator). Output component 360 includes a component that provides output information from device 300 (e.g., a display, a speaker, and/or one or more light-emitting diodes (LEDs)).

Communication interface 370 includes a transceiver-like component (e.g., a transceiver and/or a separate receiver and transmitter) that enables device 300 to communicate with other devices, such as via a wired connection, a wireless connection, or a combination of wired and wireless connections. Communication interface 370 may permit device 300 to receive information from another device and/or provide information to another device. For example, communication interface 370 may include an Ethernet interface, an optical interface, a coaxial interface, an infrared interface, a radio frequency (RF) interface, a universal serial bus (USB) interface, a Wi-Fi interface, a cellular network interface, or the like.

Device 300 may perform one or more processes described herein. Device 300 may perform these processes based on processor 320 executing software instructions stored by a non-transitory computer-readable medium, such as memory 330 and/or storage component 340. A computer-readable medium is defined herein as a non-transitory memory device. A memory device includes memory space within a single physical storage device or memory space spread across multiple physical storage devices.

Software instructions may be read into memory 330 and/or storage component 340 from another computer-readable medium or from another device via communication interface 370. When executed, software instructions stored in memory 330 and/or storage component 340 may cause processor 320 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 3 are provided as an example. In practice, device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

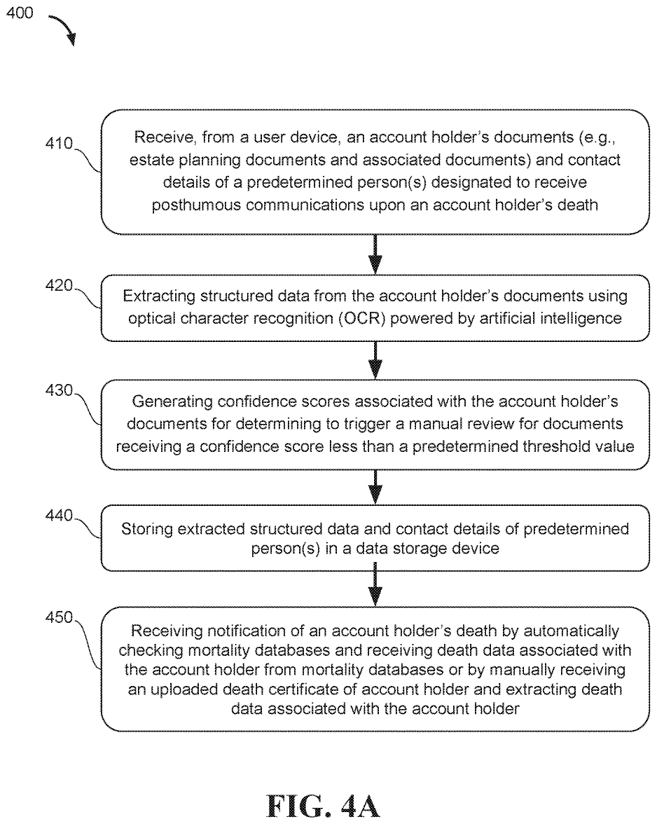

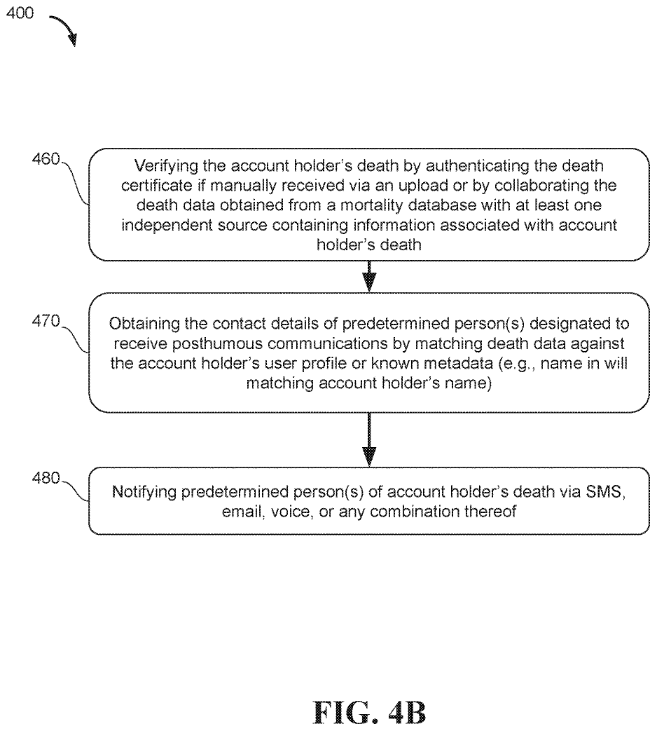

FIGS. 4A-4B is a flowchart of an example process 400 for automatically processing estate-planning documents and delivering posthumous notifications based on verified death of an account holder. In some implementations, one or more process blocks of FIG. 4 may be performed by an estate notification and document platform (e.g., estate notification and document platform 230). In some implementations, one or more process blocks of FIG. 4 may be performed by another device or a group of devices separate from or including estate notification and document platform 230, such as a user device (e.g., user device 210), a data storage device (e.g., data storage device 220), a computing resource (e.g. computing resource 234), and/or the like.

As shown in FIG. 4, process 400 may include receiving an account holder's documents (e.g., estate-planning documents and associated documents) and contact details of a predetermined person(s) designated to receive posthumous communications upon an account holder's death (block 410). For example, the estate notification and document platform 230 (e.g., using computing resources 234, processor 320, communication interface 370, and/or the like) may receive, from a user device, an account holder's documents (e.g., estate-planning documents and associated documents) and contact details of a predetermined person(s) designated to receive posthumous communications upon an account holder's death, as described above in connection with FIGS. 1A-1E.

As further shown in FIG. 4, process 400 may include extracting structured data from the account holder's documents using optical character recognition (OCR) powered by artificial intelligence (block 420). For example, the estate notification and document platform 230 (e.g., using computing resources 234, processor 320, and/or the like) may extract structured data from the account holder's documents using optical character recognition (OCR) powered by artificial intelligence, as described above in connection with FIGS. 1A-1E.

As further shown in FIG. 4, process 400 may include generating confidence scores associated with the account holder's documents for determining to trigger a manual review for documents receiving a confidence score less than a predetermined threshold value (block 430). For example, the estate notification and document platform 230 (e.g., using computing resources 234, processor 320, and/or the like) may generate confidence scores associated with the account holder's documents for determining to trigger a manual review for documents receiving a confidence score less than a predetermined threshold value, as described above in connection with FIGS. 1A-1E.

As further shown in FIG. 4, process 400 may include storing extracted structured data and contact details of predetermined person(s) in a data storage device (block 440). For example, the estate notification and document platform 230 (e.g., using computing resource 234, processor 320, memory 330, storage component 340, and/or the like) may store extracted structured data and contact details of predetermined person(s) in a data storage device, as described above in connection with FIGS. 1A-1E.

As shown in FIG. 4, process 400 may include receiving notification of an account holder's death by automatically checking mortality databases and receiving death data associated with the account holder from mortality databases or by manually receiving an uploaded death certificate of account's holder and extracting death data associated with the account holder (block 450). For example, the estate notification and document platform 230 (e.g., using computing resources 234, processor 320, communication interface 370, and/or the like) may receive notification of an account holder's death by automatically checking mortality databases and receiving death data associated with the account holder from mortality databases or by manually receiving an uploaded death certificate of account's holder and extracting death data associated with the account holder, as described above in connection with FIGS. 1A-1E.

As further shown in FIG. 4, process 400 may include verifying the account holder's death by authenticating the death certificate if manually received via an upload or by collaborating the death data obtained from a mortality database with at least one independent source containing information associated with account holder's death (block 460). For example, the estate notification and document platform 230 (e.g., using computing resources 234, processor 320, and/or the like) may verify the account holder's death by authenticating the death certificate if manually received via an upload or by collaborating the death data obtained from a mortality database with at least one independent source containing information associated with account holder's death, as described above in connection with FIGS. 1A-1E.

As further shown in FIG. 4, process 400 may include obtaining the contact details of predetermined person(s) designated to receive posthumous communications by matching death data against the account holder's user profile or known metadata (e.g., name in will matching account holder's name) (block 470). For example, the estate notification and document platform 230 (e.g., using computing resource 234, processor 320, memory 330, storage component 340, and/or the like) may obtain the contact details of predetermined person(s) designated to receive posthumous communications by matching death data against the account holder's user profile or known metadata (e.g., name in will matching account holder's name), as described above in connection with FIGS. 1A-1E.

As further shown in FIG. 4, process 400 may include notifying a predetermined person(s) of account holder's death via SMS, email, voice, or any combination thereof (block 480). For example, the estate notification and document platform 230 (e.g., using computing resources 234, processor 320, output component 360, communication interface 370, and/or the like) may notify a predetermined person(s) of account holder's death via SMS, email, voice, or any combination thereof.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

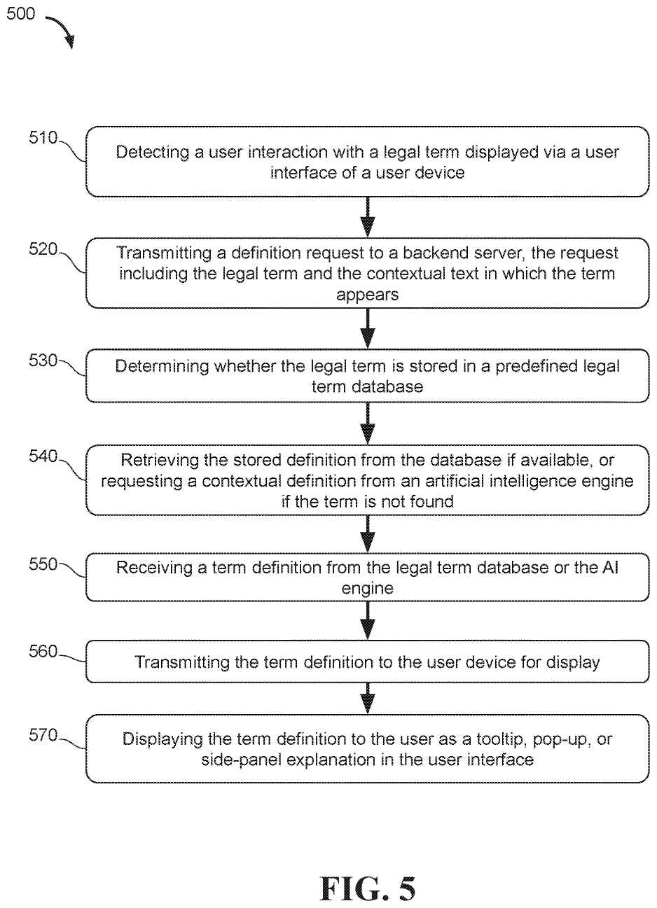

FIG. 5 is a flowchart of an example process 500 for retrieving and displaying plain-language definitions of legal terms based on user interaction with estate documents. In some implementations, one or more process blocks of FIG. 5 may be performed by the Estate Notification and Document Platform (e.g., estate notification and document platform 230). In some implementations, one or more process blocks of FIG. 5 may be performed by another device or group of devices separate from or including estate notification and document platform 230, such as a user device (e.g., user device 210), a data storage device (e.g., data storage device 220), a computing resource (e.g., computing resource 234), and/or the like.

As shown in FIG. 5, process 500 may include detecting a user interaction with a legal term displayed via a user interface of a user device (block 510). For example, the Estate Notification and Document Platform 230 (e.g., using processor 320 and communication interface 370) may detect that the user has hovered over, tapped, or clicked on a legal term displayed within a will, trust, or power of attorney document shown on the user interface.

As further shown in FIG. 5, process 500 may include transmitting a definition request to a backend server, the request including the legal term and the contextual text in which the term appears (block 520). For example, the user device 210 may send the legal term (e.g., “per stirpes”) and surrounding sentence or paragraph to the Estate Notification and Document Platform 230 via an API call to a backend service.

As further shown in FIG. 5, process 500 may include determining whether the legal term is stored in a predefined legal term database (block 530). For example, the platform 230 (e.g., using computing resource 234 and storage component 340) may query a glossary or legal term dictionary stored in memory 330 to determine if a plain-language definition for the legal term already exists.

As further shown in FIG. 5, process 500 may include retrieving the stored definition from the database if available, or requesting a contextual definition from an artificial intelligence engine if the term is not found (block 540). For example, if the definition is not in the platform's database, the platform may transmit the term and contextual text to an AI engine (e.g., a large language model or NLP system) capable of generating a plain-English explanation based on semantic understanding.

As further shown in FIG. 5, process 500 may include receiving a term definition from the legal term database or the AI engine (block 550). For example, the platform 230 may receive a database response or AI-generated definition such as: “Per stirpes” means that if a named beneficiary dies before the account holder, that person's share is passed to their children or heirs.

As further shown in FIG. 5, process 500 may include transmitting the term definition to the user device for display (block 560). For example, the definition may be returned as a JSON response or plain text message, formatted for display.

As further shown in FIG. 5, process 500 may include displaying the term definition to the user as a tooltip, pop-up, or side-panel explanation in the user interface (block 570). For example, when the definition is received, it may appear above or beside the legal term within the document being reviewed, improving user understanding without requiring external lookup.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

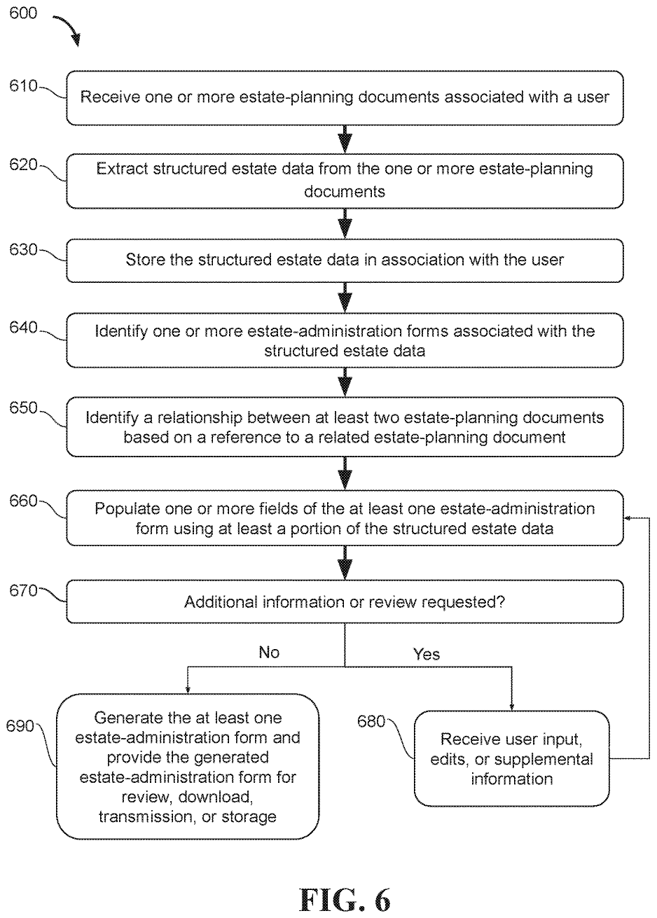

FIG. 6 is a flowchart of an example process 600 for generating an estate-administration form using structured estate data extracted from one or more estate-planning documents. In some implementations, one or more process blocks of FIG. 6 may be performed by the Estate Notification and Document Platform (e.g., estate notification and document platform 230). In some implementations, one or more process blocks of FIG. 6 may be performed by another device or group of devices separate from or including estate notification and document platform 230, such as a user device (e.g., user device 210), a data storage device (e.g., data storage device 220), a computing resource (e.g., computing resource 234), and/or the like.

As shown in FIG. 6, process 600 may include receiving one or more estate-planning documents associated with a user (block 610). For example, the Estate Notification and Document Platform 230 (e.g., using processor 320 and communication interface 370) may receive, via a user interface of user device 210, one or more uploaded estate-planning documents, such as a will, trust document, power of attorney, advance healthcare directive, deed, or beneficiary designation document.

As further shown in FIG. 6, process 600 may include extracting structured estate data from the one or more estate-planning documents (block 620). For example, the Estate Notification and Document Platform 230 may use one or more document-processing techniques, such as optical character recognition, natural-language processing, document classification, or semantic parsing, to extract structured estate data including fiduciary role information, beneficiary information, asset-disposition information, date information, witness information, notary information, healthcare instruction information, legal-clause information, or a reference to a related estate-planning document.

As further shown in FIG. 6, process 600 may include storing the structured estate data in association with the user (block 630). For example, the platform 230 (e.g., using memory 330 and/or storage component 340) may store the structured estate data in one or more machine-readable records, fields, objects, or other data structures associated with the user account.

As further shown in FIG. 6, process 600 may include identifying one or more estate-administration forms associated with the structured estate data (block 640). For example, the Estate Notification and Document Platform 230 may identify one or more forms, such as a small-estate affidavit, an affidavit of domicile, or a transfer-on-death deed, based on the type of estate-planning documents received, one or more extracted fields, one or more user selections, and/or one or more workflow conditions.

As further shown in FIG. 6, process 600 may include identifying a relationship between at least two estate-planning documents based on a reference to a related estate-planning document (block 650). For example, the platform 230 may determine that a pour-over will references a revocable trust, that a trust amendment references an earlier trust instrument, or that another estate-planning document references a related estate-planning document, and may use the relationship in selecting or populating one or more forms.

As further shown in FIG. 6, process 600 may include populating one or more fields of the at least one estate-administration form using at least a portion of the structured estate data (block 660). For example, the Estate Notification and Document Platform 230 may populate one or more form fields using fiduciary role information, beneficiary information, asset-disposition information, date information, or other extracted data associated with the user and the one or more estate-planning documents.

As further shown in FIG. 6, process 600 may include determining whether additional information or review is requested (block 670). For example, the platform 230 may determine whether one or more required fields are incomplete, whether a user has requested to edit or review the form, whether a relationship among documents indicates that supplemental information may be needed, and/or whether another validation or review condition applies.

As further shown in FIG. 6, process 600 may include receiving user input, edits, or supplemental information when additional information or review is requested (block 680). For example, user device 210 may transmit one or more edits, confirmations, corrections, or supplemental data entries to the Estate Notification and Document Platform 230 for use in updating one or more fields of the estate-administration form.

As further shown in FIG. 6, process 600 may include generating the at least one estate-administration form and providing the generated estate-administration form for review, download, transmission, or storage (block 690). For example, the Estate Notification and Document Platform 230 may generate a completed or partially completed form document in electronic format and provide the form to user device 210 for display, download, signature, transmission, or storage.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a flowchart of an example process 700 for embassy or consular filing of a power of attorney document. In some implementations, one or more process blocks of FIG. 7 may be performed by the Estate Notification and Document Platform (e.g., estate notification and document platform 230). In some implementations, one or more process blocks of FIG. 7 may be performed by another device or group of devices separate from or including estate notification and document platform 230, such as a user device (e.g., user device 210), a data storage device (e.g., data storage device 220), a computing resource (e.g., computing resource 234), and/or the like.

As shown in FIG. 7, process 700 may include receiving jurisdictional data associated with a power of attorney transaction (block 710). For example, the Estate Notification and Document Platform 230 (e.g., using processor 320 and communication interface 370) may receive, via a user interface of user device 210, information identifying a country associated with a user, a country associated with real or personal property, a country associated with one or more beneficiaries, and/or identity information associated with one or more executors, heirs, beneficiaries, co-owners, trustees, or other designated recipients.

As further shown in FIG. 7, process 700 may include determining an embassy or consular filing authority based on the jurisdictional data (block 720). For example, the Estate Notification and Document Platform 230 may apply one or more jurisdiction-specific rules, mappings, or lookup tables to determine an embassy, consulate, or other consular filing authority associated with a power of attorney transaction.

As further shown in FIG. 7, process 700 may include receiving or generating a power of attorney document (block 730). For example, the Estate Notification and Document Platform 230 may receive an uploaded power of attorney document from user device 210 or may generate a power of attorney document using structured estate data associated with the user.

As further shown in FIG. 7, process 700 may include generating a filing package for the power of attorney document (block 740). For example, the Estate Notification and Document Platform 230 may generate a filing package that includes the power of attorney document, jurisdiction-specific metadata, embassy-specific metadata, supporting documents, user identification information, estate-related information, and/or other filing data associated with the determined filing authority.

As further shown in FIG. 7, process 700 may include validating one or more embassy-authentication features of the filing package (block 750). For example, the Estate Notification and Document Platform 230 may perform seal detection, signature verification, signature-embedding analysis, anomaly detection, document-integrity analysis, image analysis, and/or another validation operation associated with the filing package.

As further shown in FIG. 7, process 700 may include determining whether the filing package satisfies one or more submission criteria (block 760). For example, the platform 230 may determine whether the filing package is complete, whether one or more required authentication features are present, whether one or more required supporting documents are included, and/or whether another submission condition is satisfied.

As further shown in FIG. 7, process 700 may include flagging the filing package for correction, supplementation, or review when the filing package does not satisfy the one or more submission criteria (block 770). For example, the Estate Notification and Document Platform 230 may transmit a message to user device 210 identifying one or more deficiencies in the filing package and requesting one or more corrections, supplemental documents, or review actions.

As further shown in FIG. 7, process 700 may include submitting the filing package to the embassy or consular filing authority when the one or more submission criteria are satisfied (block 780). For example, the Estate Notification and Document Platform 230 may submit the filing package electronically, through a portal workflow, through an assisted filing workflow, and/or through generation of a package for printing, mailing, or physical presentation.

As further shown in FIG. 7, process 700 may include receiving or determining filing status information associated with the filing package (block 790). For example, the Estate Notification and Document Platform 230 may receive a submission confirmation, a pending status, a deficiency notice, an acceptance status, or another filing-related status.

As further shown in FIG. 7, process 700 may include storing filing status information and audit-log information associated with the filing workflow (block 795). For example, the platform 230 (e.g., using memory 330 and/or storage component 340) may store one or more submission timestamps, filing status updates, validation results, recipient records, and/or audit-log records associated with the filing package.

Although FIG. 7 shows example blocks of process 700, in some implementations, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a flowchart of an example process 800 for detecting a cross-border relationship and transmitting one or more filing-related notifications. In some implementations, one or more process blocks of FIG. 8 may be performed by the Estate Notification and Document Platform (e.g., estate notification and document platform 230). In some implementations, one or more process blocks of FIG. 8 may be performed by another device or group of devices separate from or including estate notification and document platform 230, such as a user device (e.g., user device 210), a data storage device (e.g., data storage device 220), a computing resource (e.g., computing resource 234), and/or the like.

As shown in FIG. 8, process 800 may include receiving user, property, and estate-related data (block 810). For example, the Estate Notification and Document Platform 230 (e.g., using processor 320 and communication interface 370) may receive data identifying a user, one or more properties, one or more estate interests, and one or more estate-related recipients associated with a power of attorney transaction or another estate-related workflow.

As further shown in FIG. 8, process 800 may include identifying one or more jurisdictions associated with the user, property, or estate-related recipients (block 820). For example, the Estate Notification and Document Platform 230 may identify a country of residence of a user, a country in which real or personal property is located, and/or a country associated with a beneficiary, executor, trustee, co-owner, or another designated recipient.

As further shown in FIG. 8, process 800 may include detecting whether a cross-border relationship exists (block 830). For example, the Estate Notification and Document Platform 230 may compare jurisdictional information associated with a user, a property, and one or more estate-related recipients to determine whether two or more relevant jurisdictions are involved in the workflow.

As further shown in FIG. 8, process 800 may include determining whether a cross-border relationship has been detected (block 840). For example, the platform 230 may determine whether a user resides in a first country while property, estate interests, or estate-related recipients are associated with a second country, thereby indicating a cross-border relationship.

As further shown in FIG. 8, process 800 may include continuing a domestic workflow or awaiting additional data when a cross-border relationship is not detected (block 850). For example, the Estate Notification and Document Platform 230 may continue processing the workflow without invoking an embassy or consular filing path, or may wait for additional jurisdictional information before making a final determination.

As further shown in FIG. 8, process 800 may include determining one or more recipients associated with the cross-border relationship when a cross-border relationship is detected (block 860). For example, the Estate Notification and Document Platform 230 may identify one or more executors, beneficiaries, trustees, co-owners, fiduciaries, or other designated recipients associated with the cross-border workflow.

As further shown in FIG. 8, process 800 may include determining a notification rule, sequence, or recipient hierarchy (block 870). For example, the Estate Notification and Document Platform 230 may determine whether notifications should be transmitted first to an executor, then to one or more beneficiaries, whether notifications should be delayed pending a filing event, and/or whether notifications should follow one or more jurisdiction-specific rules.

As further shown in FIG. 8, process 800 may include generating one or more filing-related notifications (block 880). For example, the Estate Notification and Document Platform 230 may generate a notification indicating that a power of attorney filing package has been submitted, that a filing status has changed, that one or more supporting documents are required, and/or that another filing-related event has occurred.

As further shown in FIG. 8, process 800 may include transmitting the one or more filing-related notifications (block 890). For example, the Estate Notification and Document Platform 230 may transmit the one or more notifications to user device 210 or another recipient device using email, a portal message, a text message, an application notification, or another communication channel.

As further shown in FIG. 8, process 800 may include updating status information and audit-log information associated with the cross-border workflow (block 895). For example, the platform 230 (e.g., using memory 330 and/or storage component 340) may store one or more notification timestamps, recipient identifiers, delivery statuses, filing statuses, and/or audit-log records associated with the cross-border workflow.

Although FIG. 8 shows example blocks of process 800, in some implementations, process 800 may include additional blocks, fewer blocks, different blocks, or differently arranged blocks than those depicted in FIG. 8. Additionally, or alternatively, two or more of the blocks of process 800 may be performed in parallel.

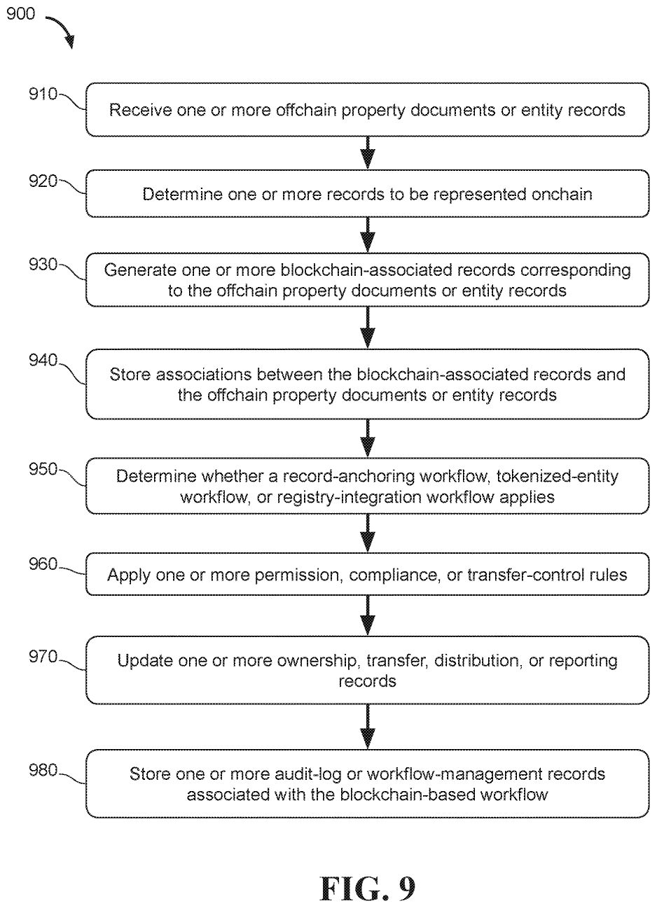

FIG. 9 is a flowchart of an example process 900 for generating and managing blockchain-associated records corresponding to offchain property documents or interests in a property-owning entity. In some implementations, one or more process blocks of FIG. 9 may be performed by the Estate Notification and Document Platform (e.g., estate notification and document platform 230). In some implementations, one or more process blocks of FIG. 9 may be performed by another device or group of devices separate from or including estate notification and document platform 230, such as a user device (e.g., user device 210), a data storage device (e.g., data storage device 220), a computing resource (e.g., computing resource 234), and/or the like.

As shown in FIG. 9, process 900 may include receiving one or more offchain property documents or entity records (block 910). For example, the Estate Notification and Document Platform 230 (e.g., using processor 320 and communication interface 370) may receive one or more deeds, title reports, title policies, surveys, mortgage documents, lien records, lease documents, homeowner-association records, trust records, entity-formation documents, operating agreements, transfer documents, or other records associated with real property or a property-owning entity.

As further shown in FIG. 9, process 900 may include determining one or more records to be represented onchain (block 920). For example, the Estate Notification and Document Platform 230 may determine whether one or more document hashes, metadata records, digital certificates, registry references, ownership records, transfer records, workflow states, approval states, maintenance records, rent-distribution records, or other administrative records are to be generated or managed as blockchain-associated records.

As further shown in FIG. 9, process 900 may include generating one or more blockchain-associated records corresponding to the offchain property documents or entity records (block 930). For example, the Estate Notification and Document Platform 230 may generate one or more hashes, metadata records, digital certificates, tokens, registry references, or other blockchain-associated records corresponding to the offchain property documents or interests in a property-owning entity.

As further shown in FIG. 9, process 900 may include storing associations between the blockchain-associated records and the offchain property documents or entity records (block 940). For example, the Estate Notification and Document Platform 230 (e.g., using memory 330 and/or storage component 340) may store one or more associations linking a blockchain-based record to a corresponding deed, title record, entity record, ownership record, transfer record, or other offchain property document.

As further shown in FIG. 9, process 900 may include determining whether a record-anchoring workflow, tokenized-entity workflow, or registry-integration workflow applies (block 950). For example, the Estate Notification and Document Platform 230 may determine whether a blockchain-associated record is to be used as a tamper-evident reference to one or more offchain property documents, whether one or more tokens are to represent interests in an entity that owns real property, or whether one or more blockchain-associated records are to be synchronized with or otherwise associated with a governmental land registry, recorder's office, title system, or other public property-record system.

As further shown in FIG. 9, process 900 may include applying one or more permission, compliance, or transfer-control rules (block 960). For example, the Estate Notification and Document Platform 230 may apply one or more smart-contract rules, transfer restrictions, holder-approval rules, investor-whitelisting rules, anti-money-laundering rules, know-your-customer rules, tax-reporting rules, jurisdiction-specific rules, or other compliance or transfer-control rules associated with the blockchain-based workflow.

As further shown in FIG. 9, process 900 may include updating one or more ownership, transfer, distribution, or reporting records (block 970). For example, the Estate Notification and Document Platform 230 may update one or more issuer records, transfer-agent records, cap-table records, consent records, ownership records, transfer records, distribution records, investor-reporting records, financing records, or collateralization-related records associated with the property or property-owning entity.

As further shown in FIG. 9, process 900 may include storing one or more audit-log or workflow-management records associated with the blockchain-based workflow (block 980). For example, the platform 230 (e.g., using memory 330 and/or storage component 340) may store one or more audit-log entries, workflow states, approval records, transfer timestamps, distribution timestamps, reporting records, or other workflow-management records associated with the blockchain-based property-record workflow.

Although FIG. 9 shows example blocks of process 900, in some implementations, process 900 may include additional blocks, fewer blocks, different blocks, or differently arranged blocks than those depicted in FIG. 9. Additionally, or alternatively, two or more of the blocks of process 900 may be performed in parallel.

The terms “comprising”, “including”, “having” are inclusive and therefore specific to the presence of stated features, steps, operations, elements, or components, but do not preclude the presence or addition of one or more other features, steps, operations, elements, or components. Orders of steps, processes, and operations may be altered when possible, and additional or alternative steps may be employed. As used in this specification, the term “or” includes any one and all combinations of the associated listed items. The term “any of” is understood to include any possible combination of referenced items, including “any one of” the referenced items. “A”, “an”, “the”, “at least one”, and “one or more” are used interchangeably to indicate that at least one of the items in present. A plurality of such items may be present unless the context clearly indicates otherwise. All values of parameters (e.g., of quantities or conditions), unless otherwise indicated expressly or clearly in view of the context, including the appended claims, are to be understood as being modified in all instances by the term “about” whether or not “about” actually appears before the value. A component that is “configured for” performing or “configured to” perform a specified function is capable of performing the specified function after further modification. In other words, the described component, when expressly configured to perform the specified function, is specifically selected, created, implemented, utilized, programmed, and/or designed for the purpose of performing the specified function.

While various embodiments have been described, the description is intended to be exemplary, rather than limiting, and it will be apparent to those of ordinary skill in the art that many more embodiments and implementations are possible that are within the scope of the embodiments. Any feature of any embodiment may be used in combination with or substituted for any other feature or element in any other embodiment unless specifically restricted. Accordingly, the embodiments are not to be restricted except in light of the attached claims or their equivalents. Also, various modifications and changes may be made within the scope of the attached claims. Although several modes for carrying out the many aspects of the present teachings have been described in detail, those familiar with the art to which these teachings relate will recognize various alternative aspects for practicing the present teachings that are within the scope of the appended claims. It is intended that all matter contained in the above description or shown in the accompanying drawings shall be interpreted as illustrative and exemplary of the entire range or alternative embodiments that an ordinarily skilled artisan would recognize as implied by, structurally and/or functionally equivalent to, or otherwise rendered obvious based upon the included content, and not as limited solely to those explicitly depicted and/or described embodiments.

What is claimed:

1. A computer system comprising:
a memory storing instructions; and
one or more processors configured to execute the instructions to:
receive one or more estate-planning documents associated with a user;
extract, from the one or more estate-planning documents, structured estate data including at least one of fiduciary role information, beneficiary information, asset-disposition information, or a reference to a related estate-planning document;
store the structured estate data in association with the user;
verify a death event associated with the user; and
transmit, in response to verifying the death event, a notification to at least one designated recipient using at least a portion of the structured estate data stored in association with the user.

2. The computer system of claim 1, wherein the one or more estate-planning documents comprise at least one of a will, a trust document, a power of attorney, an advance healthcare directive, a deed, or a beneficiary designation document.

3. The computer system of claim 1, wherein the structured estate data further includes at least one of date information, witness information, notary information, healthcare instruction information, or legal-clause information.

4. The computer system of claim 1, wherein extracting the structured estate data comprises performing optical character recognition on at least one of the one or more estate-planning documents.

5. The computer system of claim 1, wherein extracting the structured estate data comprises performing natural-language processing to identify at least one role, relationship, or legal provision within at least one of the one or more estate-planning documents.

6. The computer system of claim 1, wherein the instructions further cause the one or more processors to verify authenticity of at least one of the one or more estate-planning documents.

7. The computer system of claim 1, wherein verifying the death event comprises querying at least one mortality data source.

8. The computer system of claim 1, wherein verifying the death event comprises authenticating an uploaded death certificate.

9. The computer system of claim 1, wherein the instructions further cause the one or more processors to identify, based on the reference to the related estate-planning document, a relationship between at least two estate-planning documents.

10. A computer system comprising:
a memory storing instructions; and
one or more processors configured to execute the instructions to:
receive one or more estate-planning documents associated with a user;
extract, from the one or more estate-planning documents, structured estate data including at least beneficiary information or a reference to a related estate-planning document;
store the structured estate data in association with the user;
verify a death event associated with the user;
provide, in response to verifying the death event, at least one designated recipient access to at least a portion of at least one of the one or more estate-planning documents; and
redact, prior to providing the access, personally identifiable information, protected health information, or confidential content identified from the structured estate data extracted from the one or more estate-planning documents.

11. The computer system of claim 10, wherein the instructions further cause the one or more processors to remove at least a portion of the redacted content in response to biometric authentication.

12. The computer system of claim 10, wherein the instructions further cause the one or more processors to remove at least a portion of the redacted content in response to two-factor authentication.

13. The computer system of claim 10, wherein the instructions further cause the one or more processors to remove at least a portion of the redacted content in response to administrator approval.

14. The computer system of claim 10, wherein verifying the death event comprises querying at least one mortality data source or authenticating an uploaded death certificate.

15. The computer system of claim 10, wherein the instructions further cause the one or more processors to delay providing the access until expiration of a waiting period after verification of the death event.

16. A computer system comprising:
a memory storing instructions; and
one or more processors configured to execute the instructions to:
receive jurisdictional data associated with a power of attorney transaction;
determine, based on the jurisdictional data, an embassy or consular filing authority associated with the power of attorney transaction;
receive or generate a power of attorney document;
generate a filing package for the power of attorney document;
validate one or more authentication features of the filing package; and
submit the filing package to the embassy or consular filing authority.

17. The computer system of claim 16, wherein the jurisdictional data includes at least one of a country associated with a user, a country associated with real or personal property, a country associated with an estate interest, or a country associated with a designated recipient.

18. The computer system of claim 16, wherein the filing package includes the power of attorney document and at least one of jurisdiction-specific metadata, embassy-specific metadata, supporting documents, user identification information, or estate-related information.

19. The computer system of claim 16, wherein the one or more processors are further configured to:
detect whether a cross-border relationship exists among a filer, a property or estate interest, and one or more estate-related recipients; and
transmit one or more filing-related notifications in response to detecting the cross-border relationship.

20. The computer system of claim 16, wherein the one or more processors are further configured to store filing status information and audit-log information associated with a filing workflow for the filing package.
